(19) United States
(12) Patent Application Publication
(10) Pub. No.: US 2003/0043346 A1
(43) Pub. Date: Mar. 6, 2003

(54) Rear projection system

(76) Inventors: Hoi-Sing Kwok, Hong Kong (HK); Ho-Chi Huang, Hong Kong (HK)

Correspondence Address: James A. LaBarre, BURNS, DOANE, SWECKER & MATHIS, L.L.P., P.O. Box 1404, Alexandria, VA, 22313-1404, US

(21) Appl. No.: 09/946,604

(22) Filed: Sep. 6, 2001

(51) Int. Cl. G03B 21/14

(52) U.S. Cl. 353/20

(57) ABSTRACT

A method and apparatus for enhancing the contrast ratio of images generated on rear projection screens is disclosed. This invention provides a method of rejecting most of the scattered ambient light from both the front and the back of a rear projection screen. Polarizing films and retardation sheets are used to enhance the contrast and reject ambient light to decrease the dark state brightness in a rear projection system. Open systems where the screen is exposed as well as enclosed rear projection systems will benefit from this invention

### FIELD OF THE INVENTION

The present invention relates to a method and apparatus of enhancing the contrast of a rear projection system.

### BACKGROUND OF THE INVENTION

A typical rear projection system is shown in FIG. 1. It consists minimally of an imager 1 that converts electronic signals from an external source into an optical image appearing on imager 1, and a projection means 2 for projecting that image onto a screen 4. The viewer 6 sits on the opposite side of that screen 4 and sees the image that appears on the screen 4. The function of the rear projection screen 4 is to systematically scatter the projected image from the imager 1 in the forward direction. The control of the scattering angle in both the horizontal and vertical directions determines the gain of the screen 4. Adding features to the screen 4 can also control the contrast, brightness uniformity and sharpness (resolution) of the image. There are many designs for this rear projection screen. The present invention relates to adding features to this projection screen.

For rear projection systems with large magnification where the light beam 3 enters the screen at a large angle, a Fresnel lens 5 is usually required to make sure that all parts of the light beam 3 enter the screen at near normal directions as shown in FIG. 2.

One of the desired properties of the rear projection screen is that it should be dark when there is no image projected onto it. This will ensure that the dark state of the image remains truly dark. Thus backscattering of ambient light has to be reduced to a minimum. There are many designs for the screen itself to reduce this background light. Different techniques such as making the screen absorb light partially, or by adding black stripes onto the screen are used. Coating the screen with anti-reflection coating to reduce back reflection of ambient light is also used. These methods suffer from various drawbacks such as reduced brightness and reduced resolution of the screen. It is desirable to have a uniform forward scattering screen with a forward/backward scattering ratio of infinity. Obviously that cannot be achieved in practice.

### PRIOR ART

Rear projection systems are used to project still and moving images 1 that appears on an imager onto a screen 4 where the viewer 6 sits on the opposite side of the screen. Thus light from the imager is designed to be systematically scattered by the screen predominately in the forward direction. Many designs have taught various methods and constructions of such rear projection screens to achieve the desired goals of high brightness, high uniformity, high contrast, large viewing angle in the horizontal direction and high gain in the forward direction, among other attributes.

For example, DiLoreto et al (U.S. Pat. No. 6,076,933) teaches a method of obtaining a screen with light transmitted and dispersed having low reflectance. Okuda et al (U.S. Pat. No. 6,049,423) teaches a rear projection screen including a lenticular lens with clear and diffusing layers on light receiving and emitting sides. Takahashi et al (U.S. Pat. No. 6,046,847) teaches a rear projection screen containing Fresnel lens sheet utilizing alternative focal lengths. Abbott et al (U.S. Pat. No. 5,999,281) teaches a holographic projection screen combining an elliptical holographic diffuser and a cylindrical light-collimator.

Aoki et al (U.S. Pat. No. 5,910,826) teaches a rear projection screen and method of producing same. De Vaan (U.S. Pat. No. 5,486,884) teaches a reflecting image projection screen and image projection system comprising such a screen.

Most designs are used in conjunction with conventional cathode ray tube (CRT) imagers. Such imagers emit light that is unpolarized. Therefore the screen has to work in conjunction with unpolarized light. Recently, it is more and more popular to use liquid crystal displays (LCD) as the imager. One very crucial observation of rear liquid crystal projection displays is that the light from the imager is usually polarized. The liquid crystal display can be either the polycrystalline silicon (poly-Si) thin film transistor type or true CMOS circuits on crystalline silicon. The latter is known as liquid crystal on silicon microdisplays (LCOS). The former imager is used to form images by modulation of light in transmission. In the latter case, the image is formed by reflection modulation of light. In both cases, the modulation of light is by polarization manipulation. The light output that is projected onto the screen is necessarily polarized.

### SUMMARY OF THE INVENTION

The present invention discloses a means of reducing the background scattered ambient light by the addition of one or two films onto the rear projection screen. This method has the merits of easy implementation. It does not affect the brightness of the image, while reducing the background light significantly. The screen remains very dark when there is no image projected onto the screen.

The invention makes use of the fact that the imaged light onto the screen is polarized, and the ambient light from both the front and the back are randomly polarized. The undesirable ambient light that enters the viewing cone of the viewer 6 is reduced by adding polarizers and retardation films at strategic locations on the screen. There are several embodiments and configurations for adding the polarizer and the retardation film to the screen. The most straightforward case is to reduce ambient light from the viewer's side from being backscattered to the viewer, which is known as image wash-out. This can be done with a polarizer-quarterwave film combination. Light from the viewer side 6 will enter the projection display as polarized light. It is then turned into circularly polarized light by the retardation film 5. The background light that affects the contrast comes typically form backscattering by the scattering film on screen 4 that is used to project the image. However, in the present arrangement, upon reflection or backscattering, this light is cross polarized and will not be transmitted by the polarizing film 5. Thus the background light is greatly reduced. The dark state of the image will be affected now by the contrast of the imager and the optical system itself, and by random scattering of light inside the rear projection display. These are controlled by carefully designing the rear projection optics and the imager. The present invention ensures that the rear projection display can be viewed with a strong ambient light and that the ambient light will not affect the contrast of the display.

In addition, one of the sources of background light in a rear projection system is stray light reflection in the imager itself. These stray lights may be randomly polarized. The addition of a polarizer on the screen will reject these stray lights and enhance the contrast of the projected image.

### BRIEF DESCRIPTION OF THE DRAWINGS

These and other objects and features of the present invention will become clear from the following description taken in conjunction with the preferred embodiments thereof with reference to the accompanying drawings in which:

FIG. 1 shows a typical rear projection system,

FIG. 2 shows another typical rear projection system,

FIG. 3 shows the structure of a contrast enhancement system according to an embodiment of the invention,

FIG. 4 shows the structure of another contrast enhancement system according to an embodiment of the invention,

FIG. 5 shows the structure of another contrast enhancement system according to an embodiment of the invention,

FIG. 6 shows the structure of another contrast enhancement system according to an embodiment of the invention, and

FIG. 7 shows the structure of another contrast enhancement system according to an embodiment of the invention.

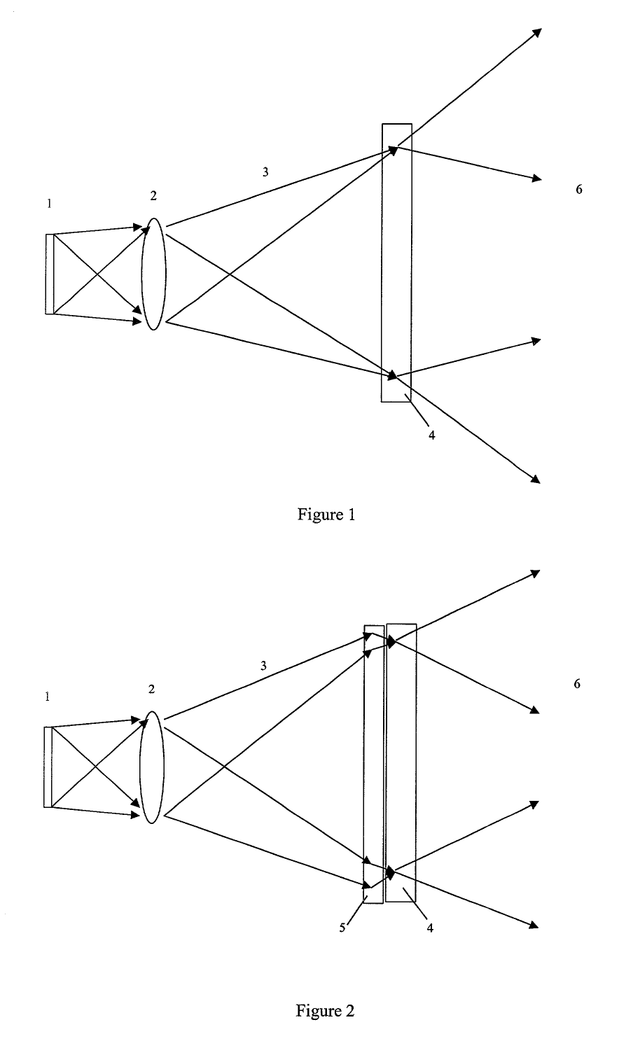

### DETAILED DESCRIPTION OF THE PREFERRED EMBODIMENTS

A major desired attribute of a rear projection screen 4 is the formation of an image on the screen with most of the light sent to the forward direction and very low backscattering of light. Since the imager 1 and the viewer 6 are located on opposite sides of the projection screen, large forward scattering ensures that the viewer will receive most of the light. Low backscattering is necessary because ambient light from the viewer's side will be backscattered and observed by the viewer as well. This light is added to the projection image as background light, which increases the dark state and decreases the contrast ratio of the image.

The structure of the screen 4 is the subject of many designs. It can consist of many lenticular lenses, lens systems or simply holographic diffusers. Its purpose is to send light to the forward direction with a well-defined angle in both the horizontal and vertical directions. The present invention can work with all types of image formation screens to enhance its contrast ratio.

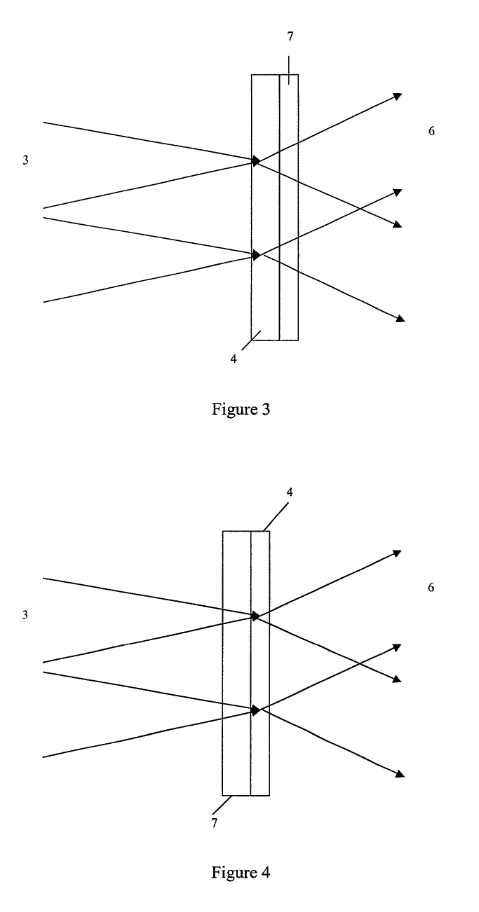

In FIG. 3, there is shown a first preferred embodiment of our invention. Not shown is the imaging system which consists of the imager 1 and the projection lens system 2 since there are many types of imagers and many types of projection lenses that can be used, and instead only shown are the additional features on the rear projection screen provided to enhance its contrast and viewability. On top of a light scattering screen 4 that can be of any type from any manufacturer, there is placed a sheet of polarizing film 7. This polarizing film 7 is disposed with its absorption axis along the polarization direction of the light beam 3 from the imager 1 and is placed on the viewer side of the screen. This light is scattered and processed by the screen 4 and is viewed by viewer at 6. The polarizing film 7 should be of the anti-glare type where back reflection is minimized. This anti-glare film will reduce the backscattering of ambient light from the viewer's side, thus reducing the background brightness of the images. Therefore the contrast is enhanced. Additionally, this polarizing film 7 will reduce the randomly scattered light from the imager 1. This will also help to reduce the background and enhance the contrast.

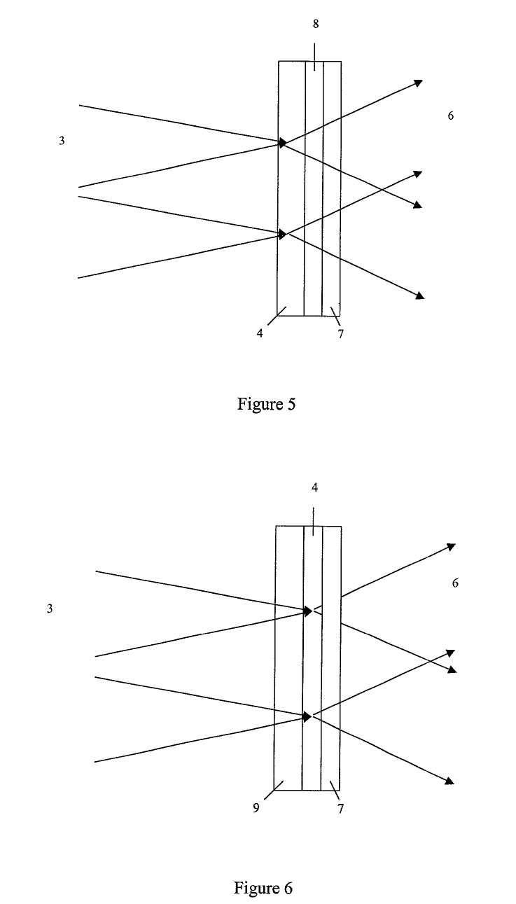

In the second embodiment of this invention as shown in FIG. 4, the polarizing film is disposed on the imager side of the imaging formation screen. This can also help to reduce the ambient light and enhance the contrast.

In the third embodiment of the present invention, FIG. 5, a broadband quarter wave retardation film 8 is added to the imager side of the polarizer 7. This quarter wave retarder 8 will further prevent ambient light which is forward scattered through the polarizer onto the scattering screen from returning to the viewer's side. This is because the backscattered light will be cross polarized from the polarizer 7 since it traverses the retardation film 8 twice.

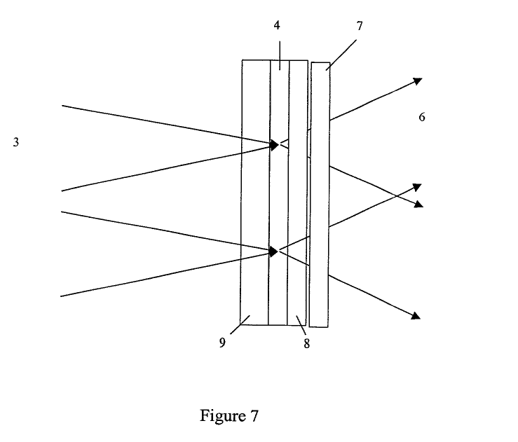

In the fourth embodiment of the present invention, FIG. 6, a second linear polarizer 9 is added on the imager side of the screen 4. This is in addition to the polarizer 7 placed on the viewer side. The additional polarizer should not reduce the brightness of the screen. But the added polarization should help to reduce the ambient light from both the imager and from the viewer's side significantly. This will again enhance contrast of the final image.

In the fifth embodiment of the present invention, FIG. 7, a retardation film 8 is placed between the polarizers 7 and 9. The retardation value of this film has to be adjusted to compensate for the depolarization effect of the scattering screen 4.

The present invention, at least in preferred forms, makes use of the fact that the output of the imager is polarised to improve the projection screen. In particular there is disclosed a method and an apparatus that can be used in conjunction with any type of rear projection screen to improve its contrast and reduce the dark state intensity. The method consists of adding a polarizing film and/or a retardation film to the screen to reduce the background light. If the polarizer has an absorption axis that is aligned with the polarization of the projected light, then there will be no loss of brightness of the image on the screen. However, ambient light from the viewer side will not be backscattered since it is polarized by the additional polarizing film. Randomly polarized ambient light from the imager side will also be reduced by half.

What is claimed is:

1. A rear projection system comprising:
a. an imager that can generate an image from an external source,
b. a projection lens system that can project the said image onto a screen,
c. a screen that can systematically scatter the image from the said projection lens system predominantly in the forward direction with prescribed angles in the horizontal and vertical directions, and
d. a linear polarizer disposed on the viewer side of said screen, wherein the transmission direction of said linear polarizer is aligned to transmit maximum light from the said imager.

2. A rear projection system comprising:
a. an imager that can generate an image from an external source,
b. a projection lens system that can project the said image onto a screen,
c. a screen that can systematically scatter the image from the said projection lens system predominantly in the forward direction with prescribed angles in the horizontal and vertical directions, and
d. a linear polarizer film disposed on the imager side of said screen, wherein the transmission direction of said linear polarizer is aligned to transmit maximum light from the said imager.

3. A rear projection system comprising:
a. an imager that can generate an image from an external source,
b. a projection lens system that can project the said image onto a screen,
c. a screen that can systematically scatter the image from the said projection lens system predominantly in the forward direction with prescribed angles in the horizontal and vertical directions,
d. a first linear polarizer disposed on the viewer side of said screen, the transmission direction of said first linear polarizer being aligned to transmit maximum light from the said imager, and
e. a second linear polarizer disposed on the imager side of said screen wherein the transmission direction of said second linear polarizer is aligned to transmit maximum light from the said imager.

4. A rear projection system comprising:
a. an imager that can generate an image from an external source,
b. a projection lens system that can project the said image onto a screen,
c. a screen that can systematically scatter the image from the said projection lens system predominantly in the forward direction with prescribed angles in the horizontal and vertical directions,
d. a linear polarizer disposed on the viewer side of said screen, the transmission direction of said linear polarizer being aligned to transmit maximum light from the said imager, and
e. a retardation film disposed in between said screen and said polarizer.

5. A rear projection system comprising:
a. an imager that can generate an image from an external source,
b. a projection lens system that can project the said image onto a screen,
c. a screen that can systematically scatter the image from the said projection lens system predominantly in the forward direction with prescribed angles in the horizontal and vertical directions,
d. a first linear polarizer disposed on the viewer side of said screen, the transmission direction of said linear polarizer being aligned to transmit maximum light from the said imager,
e. a retardation film disposed in between said screen and said first polarizer, and
f. a second linear polarizer disposed on the imager side of said screen, the transmission direction of said second linear polarizer being aligned to transmit maximum light from the said imager.

6. A rear projection system as claimed in any of claims 1 to 5 wherein said polarizer(s) are of a non-gloss anti-glaring type.

7. A rear projection system as claimed in claim 4 or 5 wherein said retardation film is a quarter wave type that can turn linear polarized light into circularly polarized light for the entire visible spectrum.

8. A rear projection system as claimed in claim 7 wherein the fast axis of said quarter wave retardation film is disposed at near 45 degrees from the absorption axis of said linear polarizer(s).

9. A rear projection system as claimed in any of claims 1 to 5 wherien the imager generating the image is a liquid crystal display.

10. A rear projection system as claimed in claim 9 wherein the liquid crystal display is a polycrystalline silicon thin film transistor active matrix display.

11. A rear projection system as claimed in claim 9 wherein the liquid crystal display is a liquid crystal on crystalline silicon microdisplay.

12. A rear projection system as claimed in any of claims 1 to 5 wherein the imager generating the image is an array of micromirrors as in a micromachined display.

13. A rear projection system as claimed in any of claims 1 to 5 wherein the imager generating the image is an array of organic light emitting diodes.

14. A rear projection system as claimed in any of claims 1 to 5 wherein the screen is a structured holographic film.

15. A rear projection system as claimed in any of claims 1 to 5 wherein the screen comprises a lenticular lens array and a light diffuser.

16. A rear projection system as claimed in any of claims 1 to 5 wherein the screen comprises light transmitting beads and a lenticular lens array.

17. A rear projection system as claimed in any of claims 1 to 5 wherein the screen comprises a structured diffuser film.

18. A rear projection system as claimed in any of claims 1 to 5 wherein the polarizer(s) and the screen are laminated together with adhesives.

19. A rear projection system as claimed in any of claims 4 and 5 wherein the polarizer(s), the retardation film and the screen are laminated together with adhesives.

20. A rear projection system as claimed in any of claims 1 to 5 wherein the linear polarizer(s) are of the dichroic absorptive type.
